(19) United States
(12) Patent Application Publication
(10) Pub. No.: US 2025/0357690 A1
(43) Pub. Date: Nov. 20, 2025

(54) CONNECTOR DEVICE

(71) Applicant: Weidmüller Interface GmbH & Co. KG, Detmold (DE)

(72) Inventors: Ralf SCHUMACHER, Lemgo (DE); Torsten DIEKMANN, Leopoldshöhe (DE); Christopher SMITH, Steinhagen (DE); Matthias NIGGEMANN, Dörentrup (DE); Jens OESTERHAUS, Detmold (DE)

(21) Appl. No.: 18/712,363

(22) PCT Filed: Jan. 18, 2023
(86) PCT No.: PCT/EP2023/051088

§ 371 Date: Oct. 29, 2024

(30) Foreign Application Priority Data
Jan. 21, 2022 (DE) 10 2022 101 383.9

(51) Int. Cl. H01R 12/70; H01R 13/629

(52) U.S. Cl. CPC H01R 12/70; H01R 13/629

(57) ABSTRACT

A connection unit (2) of a connector device for connecting at least one electrical conductor to at least one electrically conductive contact has a contact socket (7), a spring clamp (10) and a base plate (14), wherein the contact socket (7) has at least one contact spring (8, 9), wherein the spring clamp (10) has a spring arm (11) with a contact edge (11a) and a contact wall (16). The contact socket (7) and the spring clamp (10) are arranged on the base plate (14) and are electrically conductively connected by the base plate (14). A connector device has at least one connection unit (2) of this type.

The invention relates to a connection unit according to the preamble of claim 1. The invention also relates to a connector device with a connection unit of this type.

Such a connection unit is employed to connect an electrical conductor to a circuit board, whereby the circuit board has, for example, pin contacts, plug tongues, contact surfaces or the like for this purpose. The pin contacts can also be arranged in pin or connector strips, which are installed in devices and connected to electrical functional units arranged in the devices, for example for control, power supply, data transmission and the like.

A continuously increasing demand for such connection units in connector devices, e.g. in automation areas, results in the demand for improved connection units and connector devices with regard to a low number of parts, compact design and safe and simple handling.

The problem of the present invention is therefore to create an improved connection unit for a connector device.

A further problem is to provide an improved connector device.

The problem is solved by a connection unit with the features of claim 1.

The further problem is solved by a connector device with the features of claim 11.

A connection unit, according to the invention, of a connector device for connecting at least one electrical conductor to at least one electrically conductive contact has a contact socket, a spring clamp and a base plate, wherein the contact socket has at least one contact spring, wherein the spring clamp has a spring arm with a contact edge and a contact wall. The contact socket and the spring clamp are arranged on the base plate and are electrically conductively connected by the base plate.

In this way, an advantageous compact connection unit of a connector device with a reduced number of components is created.

The term “electrically conductive contact” is used here to mean pin contacts with different geometric cross-sections (circular, oval, angular), plug tongues, flat plugs with and without soldering eyes, metal surface contacts such as, for example, contact surfaces on circuit boards/conductor foils, metal surface contacts on metal parts such as, for example, housings, shields, cooling plates and the like.

A connector device according to the invention for connecting at least one electrical conductor to at least one electrically conductive contact has a housing and at least one above-described connection unit. The at least one connection unit is inserted in a receptacle of the housing, wherein the receptacle has at least one first aperture for the at least one electrical conductor and at least one second aperture for the at least one contact.

One advantage of the connector device is that it is compact and easy to handle. In addition, rapid assembly is made possible.

In one design, the base plate is a stamped-and-bent part made of an electrically conductive material, wherein the base plate has a first side wall and a second side wall as the contact wall, which are each arranged perpendicular to the base plate. Such a part is advantageously easy to manufacture.

In a further design, it is envisaged that the spring arm of the spring clamp is connected, via a curved section, to a fastening section, which is electrically conductively attached to the first side wall of the base plate. This enables an electrically conductive connection to the base plate without the need for additional components. In addition, the base plate is stiffened by the side wall.

It is advantageous that the contact wall of the spring clamp is electrically conductively connected to the base plate and is opposite the first side wall as the second side wall of the base plate, as this not only reinforces the base plate, but also enables the electrically conductive connection to the side walls in the simplest possible way.

In a further design, it is envisaged that the contact socket has at least one contact spring with a contact protrusion, which is integrally formed with the base plate. This makes it particularly easy to manufacture the contact socket together with the base plate.

Alternatively, the contact socket has two contact springs, each with a contact protrusion, which are integrally formed with the base plate. Not only the number of components, by rather also the assembly time, is advantageously reduced.

It is a particular advantage if the contact socket and the spring clamp are arranged rotated by 90° relative to on another, wherein the contact protrusions of the contact springs of the contact socket are arranged rotated by 90° relative to the contact edge of the spring clamp, since this enables a particularly compact construction with a low construction height.

If the contact socket comprises the contact spring and a contact surface of the fastening section of the spring clamp, it is advantageously possible to do without a second contact spring and thus enable an even more compact structure.

Alternatively, the contact socket has two contact springs, each with a contact protrusion, wherein the first contact spring is formed integrally with the first side wall of the base plate and the base plate, and wherein the second contact spring is formed integrally with the contact wall and the base plate. This results in a compact construction with a reduced number of parts.

In another alternative, it is envisaged that the contact socket comprises the contact spring and a contact protrusion (of a contact support which is electrically conductively connected to the first side wall). In this way, it is possible to do without the first contact spring.

In a further design, the contact socket is arranged below at least one curved section of the spring clamp. This construction is advantageously compact.

An even further design envisages that a connection space of the contact socket and a connection space of the spring clamp are arranged next to each other between a fastening leg of the spring clamp and a spring arm of the spring clamp. This also results in an advantageously compact arrangement.

One design of the connector device envisages that the housing has an actuator or/and an actuating channel for a tool for actuating a spring clamp of the at least one connection unit. Thus use of the connector device when installing and removing conductors is advantageously made possible.

Exemplary embodiments of the invention will be described below with the aid of the enclosed drawings. These exemplary embodiments serve only to illustrate the invention using preferred constructions which, however, do not definitively depict the invention. In this regard, other exemplary embodiments, modifications and equivalents of the exemplary embodiments depicted can also be realised within the framework of the claims.

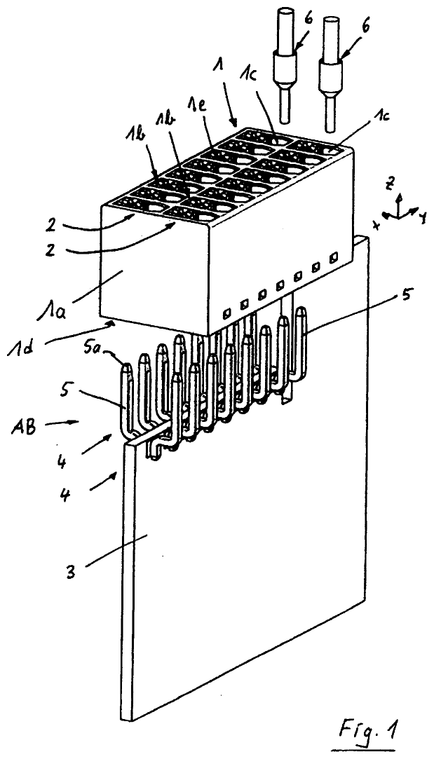

FIG. 1 a schematic perspective view of an exemplary embodiment of a connector device according to the invention;

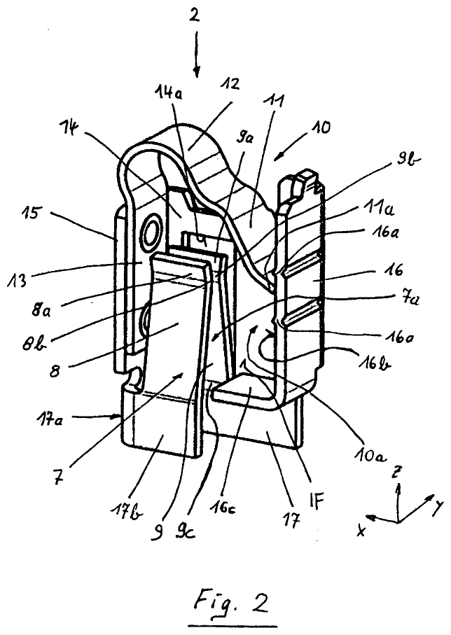

FIG. 2 a schematic perspective view of a connection unit of the connector device according to FIG. 1;

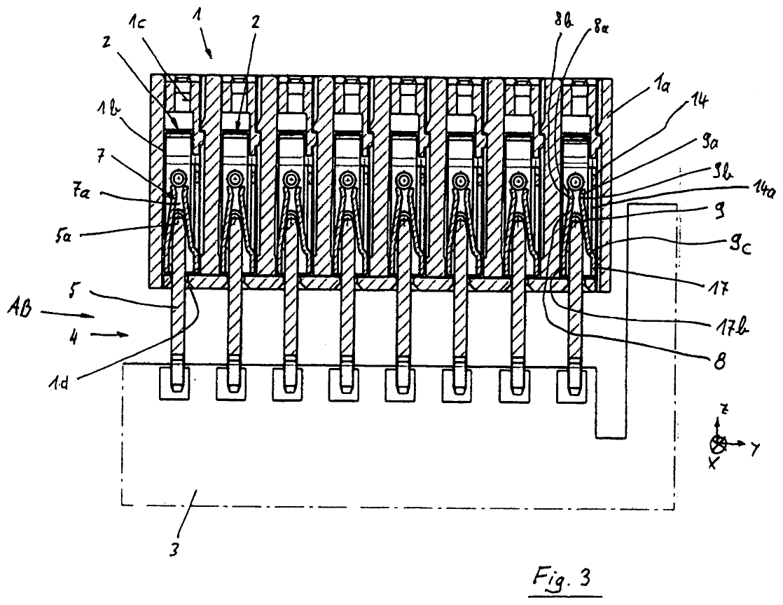

FIG. 3 a schematic longitudinal sectional view of the connector device 1 according to FIG. 1;

FIG. 4 a schematic perspective view of connection units according to

FIG. 2 in a plugged position;

FIG. 5 a schematic cross-sectional view of the connector device 1 according to FIG. 1 in a plugged position;

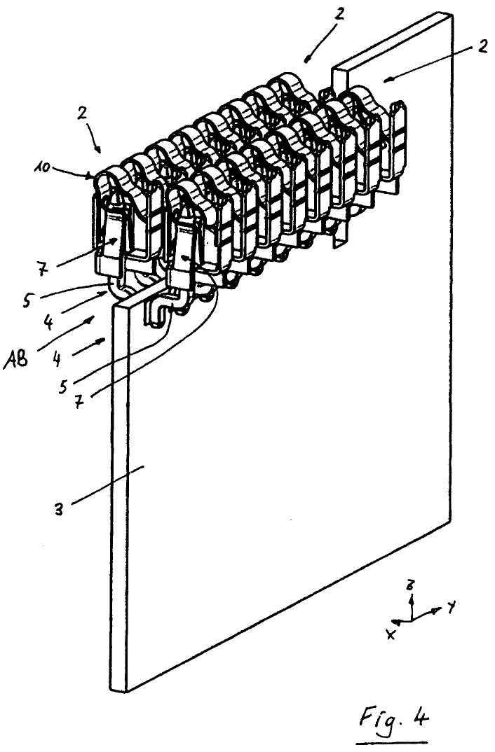

FIGS. 6-7 schematic views of a first variant of the connection unit according to FIG. 2;

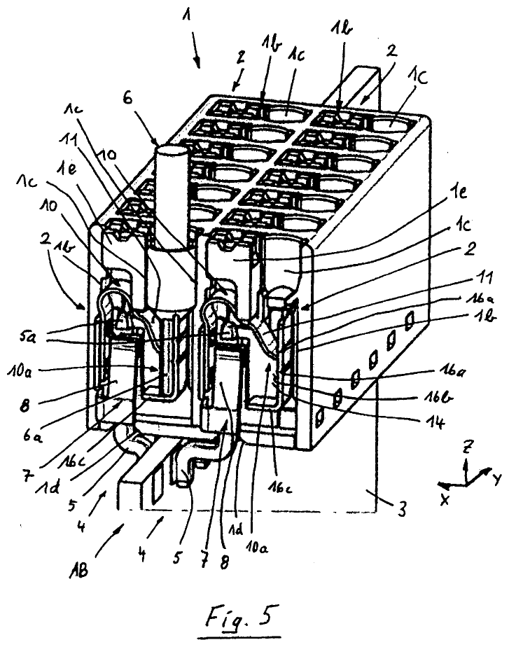

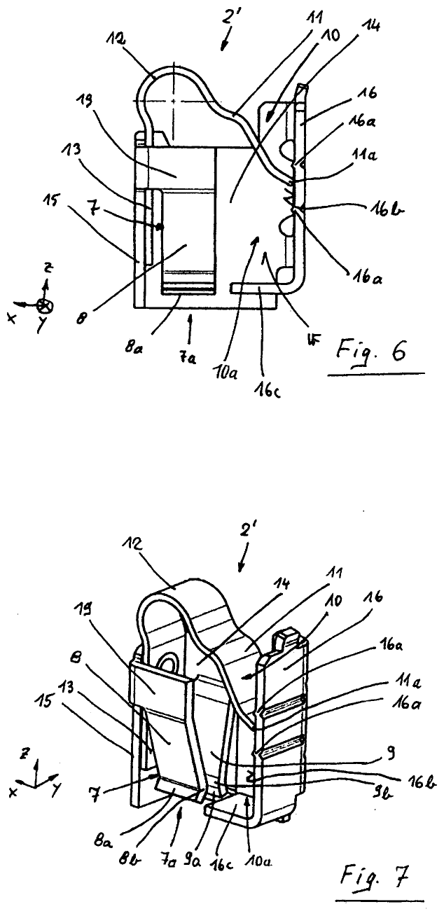

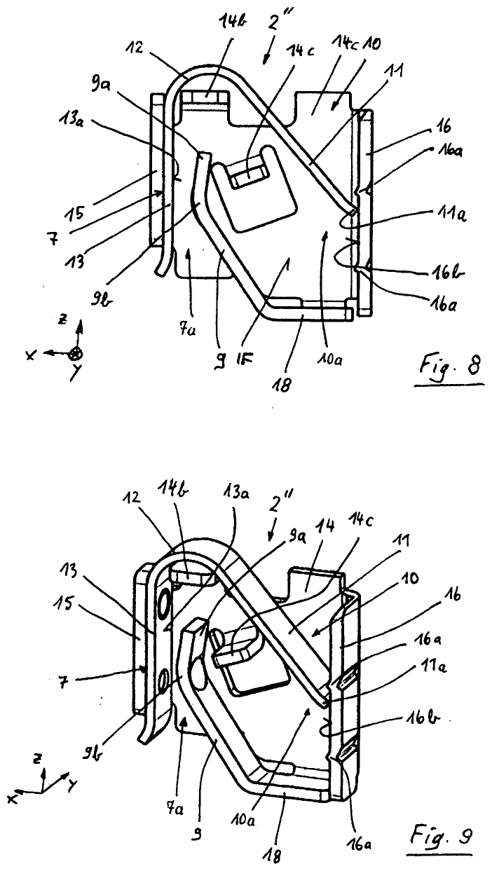

FIGS. 8-10 schematic views of a second variant of the connection unit according to FIG. 2; and

FIGS. 11-14 schematic views of additional variants of the connection unit according to FIG. 2.

Coordinates x, y, z serve the purposes of orientation. The terms “upper side”, “underside”, “laterally” and the like relate to the respective arrangement in the respective figure.

FIG. 1 depicts a schematic perspective view of an exemplary embodiment of a connector device 1 according to the invention and an associated exemplary circuit board 3.

The connector device 1 is used here to connect electrical conductors 6 to a circuit board 3. The connector device 1 comprises a housing 1a and at least one connection unit 2. Receptacles 1b are moulded into the housing 1a. In the example shown, two parallel rows, each with eight receptacles 1b are arranged in the housing 1a. A connection unit 2 according to the invention is inserted in each receptacle 1b. The receptacles 1b also form an electrical insulation of the connection units 2.

Each connection unit 2 electrically conductively connects a conductor 6 connected to it to an electrically conductive contact 5, which is formed here as a pin contact and is attached to the circuit board 3.

The term ‘electrically conductive contact’ is used here to mean pin contacts with different geometric cross-sections (circular, oval, angular), plug tongues, flat plugs with and without soldering eyes, metal surface contacts such as contact surfaces on circuit boards/conductor foils, metal surface contacts on metal parts such as housings, shields, cooling plates and the like.

The conductors 6 are plugged in through first apertures 1c of an upper side of the connector device 1 into a respective connection unit 2 and are electrically conductively clamped in the latter by means of a spring clamp 10 (see FIG. 2). The spring clamp 10 can be actuated with an actuator 1e. This is described in detail below.

The circuit board 3 shown schematically in FIG. 1 has a connector region AB with two rows of contact arrangements 4 with contacts 5. The contacts 5 run parallel to a surface of the circuit board 3 in the z-direction and are each soldered, with an offset end, to the circuit board 3 at conductor points/surfaces provided for this purpose. In a design which is not shown, for example, they can also be plugged into boreholes in the circuit board 3 and fastened accordingly. Instead of a circuit board 3, the contacts 5 can also be attached to a pin contact header (see FIG. 8).

The free ends of the contacts 5 each have a conically tapered end 5a. This makes it 10 easier to insert the contacts 5 into a respective contact socket 7 (see FIG. 2) of the connection unit 2 of the connector device 1 when the connector device 1 is pushed onto the contact arrangements 4 in the z-direction. The contacts 5 extend through a respective second aperture 1d on the underside of the connector device 1.

In FIG. 1, the connector device 1 is not yet pushed onto the contacts 5 of the circuit board 3.

FIG. 2 depicts a schematic perspective view of the inventive connection unit 2 of the connector device 1 according to FIG. 1. FIG. 3 shows a schematic longitudinal sectional view of the connector device 1 according to FIG. 1. FIG. 4 shows a schematic perspective view of connection units 2 according to FIG. 2 in a plugged position with the circuit board 3. FIG. 5 depicts a schematic cross-sectional view of the connector device 1 according to FIG. 1 in the plugged position in conjunction with the circuit board 3.

The connection unit 2 comprises the contact socket 7, the spring clamp 10 and a base plate 14.

The contact socket 7 and the spring clamp 10 are attached to the electrically conductive base plate 14. In the exemplary embodiment shown, the contact socket 7 is integrally formed with the base plate 14. The spring clamp 10 is constructed from a separate spring section and a contact wall 16 integrally formed with the base plate 14. This is described in greater detail below.

The base plate 14 is substantially rectangular and lies in an x-z plane here. A side wall 15, 16 lying in a y-z plane is arranged on opposite rims of the base plate 14 which run in the z direction. The lower rim of the base plate 14, which lies transverse to this in the x-direction, is connected to a first rim section 17, which lies in the same x-z plane as the base plate 14.

These side walls 15, 16 are formed here by folding back the associated side sections of the base plate 14 by 90°.

The first side wall 15, which is arranged on the left rim of the base plate 14 in FIG. 2, forms a fastening wall for the spring clamp 10. A lower region of the first side wall 15 is a second rim section 17a, which is connected to the first rim section 17. This second rim section 17a in turn merges into a third rim section 17b. The third rim section 17b is folded back by 90° relative to the second rim section 17a such that it is parallel to the first rim section 17.

The second side wall, which is opposite the first side wall 15 and runs parallel to it, forms a contact wall 16 of the spring clamp 10. A lower end region of the contact wall 16 is folded back by 90°, lies in an x-y plane and points towards the first side wall 15. In this way, a floor section 16c of the spring clamp 10 is formed.

The contact socket 7 has two opposing contact springs 8 and 9, which are formed as leaf springs. The first contact spring 8 is electrically conductively connected to the third rim section 17b of the base plate 14 by a lower end. The lower end of the second contact spring 9 is attached to the first rim section 17 opposite the third rim section 17b via an offset 9c (see FIG. 3). In this manner, the contact springs 8, 9 are integrally connected to the base plate 14 in this exemplary example.

The second contact spring 9 points, by one side, toward the base plate 14 in which an aperture 14a is moulded in the region of the second contact spring 9. In this example, this aperture 14a is created by punching the second contact spring 9 out of the base plate 14.

The first contact spring 8 extends from its lower end, i.e. from the third rim section 17b of the base plate 14, upwards in the z-direction at an angle in the positive y-direction towards the base plate 14 and then merges into an end section 8a. The end section 8a is bent back, i.e. pointing away from the base plate 14 in the negative y-direction. The transition between the contact spring 8 and the end section 8a forms a linear contact protrusion 8b, which extends in the x-direction.

The second contact spring 9 is arranged opposite the first contact spring 8 in a correspondingly mirrored configuration. The second contact spring 9 extends from its lower end, i.e. from the first rim section 17 of the base plate 14, upwards in the z-direction at an angle in the negative y-direction away from the base plate 14 and then merges into an end section 9a. The end section 9a is bent back, i.e. pointing towards the base plate 14 in the positive y-direction. The transition between the contact spring 9 and the end section 9a also forms a linear contact protrusion 9b, which extends in the x-direction and is opposite the contact protrusion 8a of the first contact spring 9. The contact protrusions 8b and 9b can also touch one another. The contact springs 8 and 9 can be prestressed.

The contact springs 8, 9 of the contact socket 7 forms a type of V, which is upside-down here.

A connection space 7a, which serves to receive an associated contact 5, is formed between the contact springs 8 and 9 of the contact socket 7. When the connection unit 2 is inserted in the respective receptacle 1b of the housing 1a of the connector device 1, the second aperture 1d on the underside of the housing 1a of the connector device 1 opens into the connection space 7a. This is depicted in FIGS. 3 and 5

In one design variant, which is not shown here but which is easily imaginable, the base plate 14 has only the rim sections 17, 17a, 17b. In this case, the floor section 16c lies in the same y-z plane as the second side section 16 and forms a connection to the first rim section 17. A floor section is then formed by a part of the first rim section 17 that is folded into the x-y plane.

In FIG. 3, the connector device 1 is shown in cross-section and is only partially pushed onto the contact arrangements 4 in the negative z-direction. The contacts 5 extend through the associated second apertures 1d on the underside of the housing 1a into the respective connection space 7a of the contact sockets 7. The contacts 5 are arranged between the contact springs 8, 9 and push them apart when the connector device 1 is pushed on further. When the connector device 1 is fully pushed on, the contact protrusions 8b, 9b of the contact springs 8, 9 of the contact sockets 7 are in electrically conductive contact with the respective contacts 5.

In a different configuration of the connector region AB of the circuit board 3, the connector region AB has a comb-like edge with electrically conductive contact surfaces. This is not shown, but is easily imaginable. The contact surfaces of the connector region AB of the circuit board 3 consist of the copper lamination of the circuit board 3 and can be uncoated or tin-plated, silver-plated, gold-plated or the like. The protruding contact surfaces are rectangular, for example. The second apertures on the underside of the connector device 1, like the contact sockets 7 too, correspond to the contact surfaces of the circuit board 3. The contact surfaces of the circuit board 3 can also be formed in such a way that they correspond to the contact sockets. In this way, the connector device 1 can be used in a variety of ways both for pin contacts and for other types of contacts.

The spring clamp 10 comprises a spring arm 11 with an end section with a contact edge 11a, a curved section 12, a fastening section 13 and the second side wall 16 as a contact wall.

The spring arm 11 is formed here with several opposing bends and is connected to the fastening section 13 via the curved section 12.

The fastening section 13 runs in a straight line parallel in the z-direction in electrically conductive contact with the first side wall 15 of the base plate 14 and is fastened to the first side wall 15, e.g. with rivets as shown here. Other fastenings are of course possible.

The upper end of the fastening section 13 is adjoined by the curved section 12, which, in the state shown in FIG. 2 installed in the base plate 14, has an angle of approximately 180° and is thereby tensioned. In this manner, the spring arm 11 is pressed with its contact edge 11a against a contact side 16b of the contact wall 16 (second side wall) facing the first side wall 15 under pretension of the curved section 12 and the spring arm 11 with its bends.

The contact side 16b of the contact wall 16 additionally has elongated contact protrusions 16a. In the example shown, there are two contact protrusions 16a that extend in the y-direction. In the position of the spring clamp 10 shown in FIG. 2, the contact edge 11a of the end section lies, without a clamped conductor, between the contact protrusions 16a parallel to them in the y-direction on the contact side 16b.

In this exemplary embodiment, the contact protrusions 16a and the contact edge 11a of the end section of the spring clamp 10 are arranged rotated by 90° in the y-direction relative to the contact protrusions 8b, 9b of the contact springs 8, 9 of the contact socket 7. In addition, an imaginary swivelling axis of the spring arm 11 of the spring clamp 10 runs in the y-direction, whereas imaginary swivelling axes of the contact protrusions 8b, 9b of the contact springs 8, 9 run in the x-direction rotated by 90° relative to the y-direction. In other words, the spring clamp 10 is arranged rotated by 90° around the z-axis in relation to the contact socket 7.

An inner surface IF of the base plate 14, the contact side 16b of the second side wall 16 of the base plate 14 and the floor section 16c of the second side wall 16 form a connection space 10a for a conductor 6 to be clamped in the spring clamp 10. This is depicted in FIG. 5.

In the shown exemplary embodiment of the base plate 14, this is formed from a metallic material integrally together with the contact springs 8, 9, the side walls 15, 16 and the rim sections 17, 17a, 17b, e.g. as a stamped-and-bent part.

FIG. 4 shows connection units 2 according to FIG. 2 in a plugged position with the circuit board 3 without the housing 1a of the connector device 1, which, with the receptacles 1b for the connection units 2, fixes them in the appropriate mechanical arrangement in relation to the contact arrangements 4 and insulates them electrically from each other.

FIG. 5 shows the plugged position of the connector device 1 in connection with contacts 5 of the circuit board 3 together with a clamped conductor 6.

The conductor 6, guided through the first aperture 1c of the upper side of the housing 1a of the connector device 1, is received in the connection receptacle 10a of the spring clamp 10 of the connection unit 2 and is clamped to the contact side 16b of the second side wall 16 by the spring arm 11 of the spring clamp 10. For this purpose, the spring arm 11 of the spring clamp 10 was previously pressed downwards in the z-direction by an actuator 1e in order to facilitate insertion of the conductor 6 into the connection space 10a. It is also possible for the conductor 6 to be inserted into the spring clamp 10 without pressing the actuator 1e. In this case, the floor section 16c forms a stop for the insertion depth of the conductor 6.

After the actuator 1e is released, the spring arm 11, by its contact edge 11a, presses the conductor 6 against the contact protrusions 16a and the contact side 16b of the second side wall 16.

In this way, an electrically conductive connection of the conductor 6 and the contact 5 is established between the spring clamp 10 and the pin socket 7 by means of the electrically conductive base plate 14 of the connection unit 2, to which both the spring clamp 10 and the pin socket 7 are electrically conductively connected.

FIG. 6 shows a schematic side view of a connection unit 2′ in a first variant of the connection unit 2 according to FIG. 2. In this regard, FIG. 7 shows a schematic perspective view.

The connection unit 2′ in the first variant differs from the design according to FIG. 2 in the following points.

The base plate 14 is shortened in the negative z-direction and therefore has no lower rim section 17.

The contact springs 8, 9 of the contact socket 7 are arranged rotated by 90° around the x-axis. As a result, the end sections 8a, 9a of the contact springs 8, 9 are located in a lower region of the base plate 14 next to the floor section 16c. When the connection unit 2′ is inserted in the housing 1a of the connection unit 1, these end sections 8a, 9a are situated closely in front of the second aperture 1d on the underside of the housing 1a.

The other ends of the contact springs 8, 9 of the contact socket 7 are therefore fastened in an upper region of the base plate 14. The other end of the first contact spring 8 is connected to the fastening section 13 via a connecting section 19. This connecting section 19 runs parallel to the base plate 14 in an x-z plane. The other end of the second contact spring 9 is attached oppositely directly to the base plate 14.

The contact springs 8, 9 form a type of upside-down V.

The spring clamp 10 is unchanged and is arranged rotated by 90° around the z-axis in relation to the contact socket 7.

FIG. 8 shows a schematic side view of a connection unit 2″ in a second variant of the connection unit 2 according to FIG. 2. In this regard, FIG. 9 shows a schematic perspective view. FIG. 10 depicts a part of the connection device 1 with the connection unit 2″ in the second variant.

The connection unit 2″ in the second variant differs from the design according to FIG. 2 in the following points.

The contact socket 7 comprises a contact surface 13a of the fastening section 13 of the spring clamp 10 and a contact spring 9.

The second contact spring 9 has a lower end which, as a connecting section 18, is a rim section of the base plate 14 that is bent by 90° with respect to the base plate 14 and lies in an x-y plane. Half of this connecting section 18, i.e. with its right end region, which is situated close to the lower end of the second side wall 16, is connected to the base plate 14. The other half of the rim section 18 extends further up to approximately the centre of the lower side of the base plate 14 and then merges in a curve into the second contact spring 9. The second contact spring 9 then runs at an angle upwards in the positive x-direction towards the contact surface 13a of the fastening section 13 of the spring clamp 10 and then merges via the contact protrusion 9b into the end section 9a, which is bent over towards the second side wall 16.

Instead of a first contact spring 8 of the contact socket 7, the contact surface 13a is formed by the inside of the fastening section 13 of the spring clamp 10. As already described above, the fastening section 13 is fastened to the first side wall 15 of the base plate 14 and also has at its free end an end section 13b which is bent outwards, i.e. pointing in the positive x-direction away from the second contact spring 9. It forms a plug-in aid for the contact 5 (see FIG. 10) in the connection space 7a of the contact socket 7. The connection space 7a is defined by the contact surface 13a of the fastening section 13 of the spring clamp 10 and by the second contact spring 9 of the contact socket 7. Part of the second contact spring 9 and the contact surface 13a of the fastening section 13 form a type of upside-down V.

In contrast to the design according to FIG. 2, the spring clamp 10 has a straight spring arm 11.

The contact edge 11a of the end section of the spring arm 11 of the spring clamp 10 and the contact protrusion 9b of the second contact spring 9 of the contact socket 7 are situated parallel to each other in the y-direction.

The connecting section 18 forms the floor section 16c of the connection space 10a of the spring clamp 10.

A wall section 14b of the upper side of the base plate 14 protrudes in an x-y plane into the curved section 12 of the spring clamp 10. The wall section 14b shortens the resilient length of the spring arm 11 of the spring clamp for larger cross-sections of the conductor 6 to be connected, thereby increasing the clamping forces of the spring arm 11.

A protrusion 14c, which protrudes from the inner surface IF of the base plate 14 in the vicinity of the end section 9a of the second contact spring 9, forms a stop for the spring arm 11 of the spring clamp 10.

Due to the shortened base plate 14 in the z-direction, the housing 1a of the connector device 1 for the connection unit 2″ in the second variant can also be formed to be shorter in the z-direction. FIG. 10 shows an example of this.

The connector device 1 has an additional locking mechanism VR as a latching mechanism in co-operation with a counterpart of a pin header SL. The pin header SL can, for example, be plugged and soldered into boreholes in the circuit board 3. It is also conceivable that the contacts 5 of the pin header SL have soldered sections for connection to other conductors, whereby the pin header SL is fastened in a housing of a device.

The spring clamp 10 does not have an actuator here. An actuating channel 1f is moulded into the wall of the receptacle 1b of the housing 1a for the connection unit 2″, above the spring arm 11 of the spring clamp 10, through which actuating channel the spring arm 11 can be actuated by means of a suitable tool.

The first apertures 1c of the upper side of the housing 1a of the connector device 1 are provided here side by side with additional lateral webs.

FIG. 11 shows a schematic side view of a connection unit 2″ in a third variant of the connection unit 2 according to FIG. 2. In this regard, FIG. 12 shows a schematic perspective view.

The connection unit 2″′ in the third variant differs from the design according to FIG. 2 as follows.

The contact socket 7 comprises a first contact spring 13a and a second contact spring 9.

The second contact spring 9 has a lower end which is a connecting section 18 and which is situated in an x-y plane. This connecting section 18 is connected (here as a bent-over extension section) to the second side wall 16, continues to approximately the centre of the lower side of the base plate 14 and then merges into the second contact spring 9 in a narrow curve. The second contact spring 9 then runs at an angle upwards in the positive x-direction towards the first side wall 15 and then merges via the contact protrusion 9b into the end section 9a, which is bent over to the second side wall 16.

The first contact spring 8 of the contact socket 7 is formed from an extension of the lower end of the first side wall 15, which is arranged in a curved connecting section 18a around the lower end of the fastening section 13 of the spring clamp 10 and then merges into the first contact spring 8.

The connection space 7a is defined by the contact spring 8 and the second contact spring 9 of the contact socket 7. The contact springs 8 and 9 form a type of upside-down V.

The contact edge 11a of the end section of the spring arm 11 of the spring clamp 10 and the contact protrusion 9b of the second contact spring 9 of the contact socket 7 are situated parallel to each other in the y-direction.

The connecting section 18 forms the floor section 16c of the connection space 10a of the spring clamp 10.

The spring clamp 10 is constructed without floor section 16c according to the design according to FIG. 2.

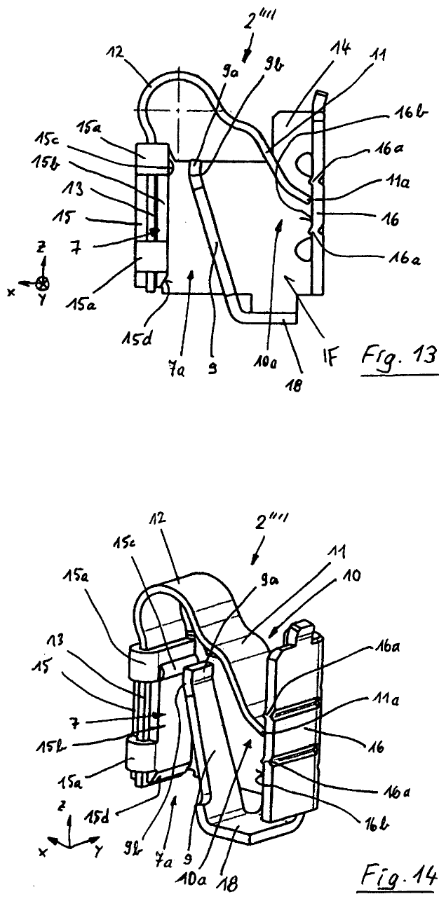

FIG. 13 shows a schematic side view of a connection unit 2″″ in a fourth variant of the connection unit 2 according to FIG. 2. FIG. 14 shows a schematic perspective view in this regard.

The connection unit 2″″ in the fourth variant differs from the design according to FIG. 2 in the following points.

The contact socket 7 comprises a contact support 15b with a contact protrusion 15c and a second contact spring 9.

The contact support 15b is provided instead of a first contact spring 8 of the contact socket 7. The contact support 15 is a type of rectangular plate, similar to the first side wall 15, arranged parallel to the first side wall 15 and is connected to it at its ends via one lug-like connecting section 15a in each case. The fastening section 13 of the spring clamp 10 is arranged between the first side wall 15 and the contact support 15b. The lug-like connecting sections 15a are designed in a curved manner.

The contact protrusion 15c is arranged in an upper region of the contact support 15b. The contact protrusion 15c is electrically conductively applied, e.g. welded, riveted or the like, to the contact support 15b as an elongated bead.

The contact support 15b also has, at its lower end, a bevel edge or chamfer 15dwhich forms a plug-in aid for the contact 5 in the connection space 7a of the contact socket 7. The connection space 7a is defined by the contact support 15b and the second contact spring 9 of the contact socket 7. The second contact spring 9 and the contact support 15b form one half of an upside-down V.

The second contact spring 9 has a lower end which, as a connecting section 18, is a rim section of the base plate 14 that is bent by 90° with respect to the base plate 14 and lies in an x-y plane. This connecting section 18 is connected to the base plate 14 and then merges in an arc into the second contact spring 9. The second contact spring 9 then runs at an angle upwards in the positive x-direction towards the contact support 15b on the first side wall 15 and then merges via the contact protrusion 9b into the end section 9a, which is bent over to the second side wall 16.

The contact edge 11a of the end section of the spring arm 11 of the spring clamp 10 and the contact protrusion 15c of the contact support 15b of the contact socket 7 are situated parallel to each other in the y-direction.

The connecting section 18 forms the floor section 16c of the connection space 10a of the spring clamp 10.

The spring clamp 10 is constructed without floor section 16c according to the design according to FIG. 2.

In all connection units 2′, 2″, 2″′, 2″″, the connection spaces 7a and 10a are arranged next to each other. The contact sockets 7 are located between the fastening leg 13 of the spring clamp 10 and the spring arm 11 of the spring clamp 10 in each connection unit 2′, 2″, 2″′, 2″″. In addition, the contact sockets 7 are arranged below at least the curved section 12 of the spring clamp 10 in each connection unit 2′, 2″, 2″′, 2″″.

The base plate 14 of the connection units 2′, 2″, 2″′, 2″″ can each be formed in such a way that its surface area is reduced to a strip. Such a strip can be arranged, in the case of the connection units 2′ (FIGS. 6-7) and 2″ (FIG. 8-9), in the upper region between the side walls 15, 16. In the case of connection units 2″′ (FIGS. 11-12) and 2″″ (FIG. 13-14), it is located in a lower region.

The invention is not limited to the embodiments depicted above. The invention can be modified within the scope of the appended claims.

It is thus conceivable that the respective contact socket 7 of the exemplary embodiment according to FIG. 2 and the variant according to FIGS. 6 and 7 have a contact surface or a contact protrusion on the inner surface IF of the base plate 14 instead of the second contact spring 9.

### REFERENCE NUMBERS

1 connector device
1a housing
1b receptacle
1c, 1d aperture
1e actuator
2, 2′, 2″, 2″′, 2″″ connection unit
3 circuit board
4 contact arrangement
5 contact
5a end
6 conductor
7 contact socket
7a connection space
8, 9 contact spring
8a, 9a end section
8b, 9b contact protrusion
9c offset
10 spring clamp
10a connection space
11 spring arm
9a end section
12 curved section
13 fastening section
13a contact surface
13b end section
14 base plate
14a aperture
14b wall section
14c protrusion
15 side wall
321 connecting section
15b contact support
15c contact protrusion
15d chamfer
16 side wall
16a contact protrusion
16b contact side
16c floor section
17, 17a, 17b rim section
18, 18a; 19 connecting section
AB connector region
IF inner surface
SL pin header
VR locking mechanism
x, y, z coordinates

1. A connection unit (2, 2′, 2″, 2″′, 2″″) of a connector device (1) for connecting at least one electrical conductor (6) having at least one electrically conductive contact (5), having a contact socket (7), a spring clamp (10) and a base plate (14), wherein the contact socket (7) has at least one contact spring (8, 9), wherein the spring clamp (10) has a spring arm (11) with a contact edge (11a) and a contact wall (16);
characterised in that
the contact socket (7) and the spring clamp (10) are arranged on the base plate (14) and are electrically conductively connected by the base plate (14).

2. The connection unit (2, 2′, 2″, 2″′, 2″″) according to claim 1, characterised in that the base plate (14) is a stamped-and-bent part made of an electrically conductive material, wherein the base plate (14) has a first side wall (15) and a second side wall as the contact wall (16), which are each arranged perpendicular to the base plate (14).

3. The connection unit (2, 2′, 2″, 2″′, 2″″) according to claim 1 or 2, characterised in that the spring arm (11) of the spring clamp (10) is connected, via a curved section (12), to a fastening section (13), which is electrically conductively attached to the first side wall (15) of the base plate (14).

4. The connection unit (2, 2′, 2″, 2″′, 2″″) according to one of the preceding claims, characterised in that the contact wall (16) of the spring clamp (10) is electrically conductively connected to the base plate (14) and is situated opposite the first side wall (15) as a second side wall of the base plate (14).

5. The connection unit (2, 2′, 2″, 2″′, 2″″) according to one of the preceding claims, characterised in that the contact socket (7) has at least one contact spring (8, 9) with a contact protrusion (8b, 9b), which is formed integrally with the base plate (14).

6. The connection unit (2, 2′, 2″′) according to one of claims 1 to 5, characterised in that the contact socket (7) has two contact springs (8, 9), each with a contact protrusion (8b, 9b), which is formed integrally with the base plate (14).

7. The connection unit (2, 2′) according to one of the preceding claims, characterised in that the contact socket (7) and the spring clamp (10) are arranged rotated by 90° relative to on another, wherein the contact protrusions (8b, 9b) of the contact springs (8, 9) of the contact socket (7) are arranged rotated by 90° relative to the contact edge (11a) of the spring clamp (10).

8. The connection unit (2″) according to one of claims 1 to 5, characterised in that the contact socket (7) comprises the contact spring (9) and a contact surface (13a) of the fastening section (13) of the spring clamp (10).

9. The connection unit (2″′) according to one of claims 1 to 5, characterised in that the contact socket (7) has two contact springs (8, 9), each with a contact protrusion (8b, 9b), wherein the first contact spring (8) is formed integrally with the first side wall (15) of the base plate (14) and the base plate (14), and wherein the second contact spring (9) is formed integrally with the contact wall (16) and the base plate (14).

10. The connection unit (2″″) according to one of claims 1 to 5, characterised in that the contact socket (7) comprises the contact spring (9) and a contact protrusion (15c) of a contact support (15b) which is electrically conductively connected to the first side wall (15).

11. The connection unit (2″″) according to one of the preceding claims, characterised in that the contact socket (7) is arranged below at least one curved section (12) of the spring clamp (10).

12. The connection unit (2″″) according to one of the preceding claims, characterised in that a connection space (7a) of the contact socket (7) and a connection space (10a) of the spring clamp (10) are arranged alongside one another between a fastening leg (13) of the spring clamp (10) and a spring arm (11) of the spring clamp (10).

13. A connector device (1) for connecting at least one electrical conductor (6) to at least one electrically conductive contact (5), having a housing (1a) and at least one connection unit (2, 2′, 2″, 2″, 2″) according to one of the preceding claims,
characterised in that
the at least one connection unit (2, 2′, 2″, 2″′, 2″″) is inserted in a receptacle (1b) of the housing (1a), wherein the receptacle (1b) has at least one first aperture (1c) for the at least one electrical conductor (6) and at least one second aperture (1d) for the at least one contact (5).

14. The connector device (1) according to claim 13, characterised in that the housing (1a) has an actuator (1e) or/and an actuating channel (1e) for a tool for actuating a spring clamp (10) of the at least one connection unit (2, 2′, 2″, 2″′, 2″″).
